(19) United States
(12) Patent Application Publication
(10) Pub. No.: US 2005/0219731 A1
(43) Pub. Date: Oct. 6, 2005

(54) Magnetic disk drive with a use time limiting function

(75) Inventor: Yoshiju Watanabe, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., Amsterdam (NL)

(21) Appl. No.: 11/100,108

(22) Filed: Apr. 5, 2005

(30) Foreign Application Priority Data
Apr. 6, 2004 (JP) 2004-111862

(51) Int. Cl. G11B 19/04; G11B 19/02

(52) U.S. Cl. 360/60; 360/69

(57) ABSTRACT

Embodiments of the invention properly limit the contents use time in a contents rental system. In one embodiment, a magnetic disk drive includes a time-based operation control module, which comprises a use time limit (Tlimit) setup unit, a use time limit retention unit, a control unit, a last use time (Tlast) retention unit, a present time (Tnow) retention unit, and a counter. The employed configuration is such that Tlast is not transferred out of the magnetic disk drive. Tlimit can be set only once or can be updated concurrently with data. While the magnetic disk drive is used, Tnow is acquired via an interface upon command from a host. The control unit checks Tlimit and Tlast to judge whether Tlast<Tnow<Tlimit. The interface permits data access from an HDC/microcomputer upon command from the host device only when Tlast<Tnow<Tlimit.

### CROSS-REFERENCES TO RELATED APPLICATIONS

This application claims priority from Japanese Patent Application No. JP2004-111862, filed Apr. 6, 2004, the entire disclosure of which is incorporated herein by reference.

### BACKGROUND OF THE INVENTION

The present invention relates to the use of contents (data) that are recorded on a magnetic disk drive, and more particularly to a magnetic disk drive that has a use time limiting function.

A rental system in which a magnetic disk drive is used like a rental video tape is known. In such a system, the use of contents is usually limited. As disclosed, for instance, in Japanese Patent Laid-open No. 2001-297273, a time limit is imposed on the contents stored in a magnetic disk drive, and an external adapter prevents the contents from being transferred out to a display device by using the information about a rental period, which is recorded in the magnetic disk drive as a use limit time.

### BRIEF SUMMARY OF THE INVENTION

When the above method is used, an illegal operation can be performed, for instance, by delaying the adapter time or manipulating another personal computer or like device to rewrite the information about a rental period, which is the use time limit information stored in the magnetic disk drive. The contents can then be accessed even after the expiry of a use time limit. Therefore, when the above technique is employed, it is difficult to properly exercise the use time limiting function.

It is a feature of the present invention to properly limit the contents use time by retaining the information about a use time limit within the magnetic disk drive, supplying only the minimum required information to the outside, judging within the magnetic disk drive whether the use time limit is exceeded, and preventing the judgment conditions from being externally controlled.

In accordance with an aspect of the present invention, the magnetic disk drive internally retains a use time limit (Tlimit) and the last use time (Tlast), acquires the present time (Tnow) from a host device upon command execution, and permits access to the contents (data) of the magnetic disk drive only when Tlast<Tnow<Tlimit. If Tlast>Tnow, Tnow>Tlimit, or Tlast>Tlimit, the contents of the magnetic disk drive cannot be accessed.

Further, the information about the last use time (Tlast) will not be transferred out of the magnetic disk drive. The use time limit (Tlimit) can be updated only once as far as it is updated together with data. While the magnetic disk drive operates after present time (Tnow) acquisition, the availability time is decreased according to the use time by updating the present time (Tnow) and last use time (Tlast) as needed with an internal counter or like device. This ensures that a maximum use time limit can be imposed in relation to an illegal time manipulation (e.g., delaying the time) when the present time (Tnow) is to be acquired from the outside.

When the use time limit (Tlimit) is to be updated, data protection is provided, for instance, by erasing data, by updating key information while generating/using a cryptographic key within a built-in cryptographic device only, or by temporarily permitting a data write and subsequently permitting data playback only.

Since the present invention retains use time information within the magnetic disk drive, judges within the magnetic disk drive whether the use time limit is exceeded, and controls the output of the contents (data) inside the magnetic disk drive, it properly exercises the use time limiting function even when illegal access is gained from an external device.

### BRIEF DESCRIPTION OF THE DRAWINGS

FIG. 1 shows the configuration of a time-based operation control module according to a first embodiment of the present invention.

FIG. 2 shows the configuration of a time-based operation control module according to a second embodiment of the present invention.

FIG. 3 shows the configuration of a time-based operation control module according to a third embodiment of the present invention.

FIG. 4 is a conceptional diagram that illustrates the operation of a magnetic disk drive according to an embodiment of the present invention along a time base.

FIG. 5 is a conceptional diagram that illustrates the operation of a magnetic disk drive according to an embodiment of the present invention along a time base.

FIG. 6 is a conceptional diagram that illustrates the operation of a magnetic disk drive according to an embodiment of the present invention along a time base.

FIG. 7 shows the state transitions of the first embodiment of a magnetic disk drive according to the present invention.

FIG. 8 shows the state transitions of the second and third embodiments of a magnetic disk drive according to the present invention.

FIG. 9 shows the state transitions that can be applied to the second and third embodiments of a magnetic disk drive according to the present invention.

FIG. 10 is a flowchart that illustrates how the time-based operation control modules according to the first, second, and third embodiments of the present invention operates upon power ON.

FIG. 11A is a flowchart illustrating an operation that is performed to set a use time limit (Tlimit) in accordance with the first and second embodiments of the present invention.

FIG. 11B is a flowchart illustrating an operation that is performed to update the use time limit (Tlimit) in accordance with the second embodiment of the present invention.

FIG. 11C is a flowchart illustrating an operation that is performed to set/update the use time limit (Tlimit) in accordance with the third embodiment of the present invention.

FIG. 12A is a flowchart illustrating an operation that is performed to delete the use time limit (Tlimit) in accordance with the second embodiment of the present invention.

FIG. 12B is a flowchart illustrating an operation that is performed to delete the use time limit (Tlimit) in accordance with the third embodiment of the present invention.

FIG. 13 is a flowchart illustrating an operation that is performed to update the present time (Tnow) and last use time (Tlast) in accordance with the first, second, and third embodiments of the present invention.

FIG. 14 illustrates the configuration of a magnetic disk drive according to the first and second embodiments of the present invention.

FIG. 15 illustrates the configuration of a magnetic disk drive according to the third embodiment of the present invention.

FIG. 16 illustrates a modified version of the magnetic disk drive according to the third embodiment of the present invention.

### DETAILED DESCRIPTION OF THE INVENTION

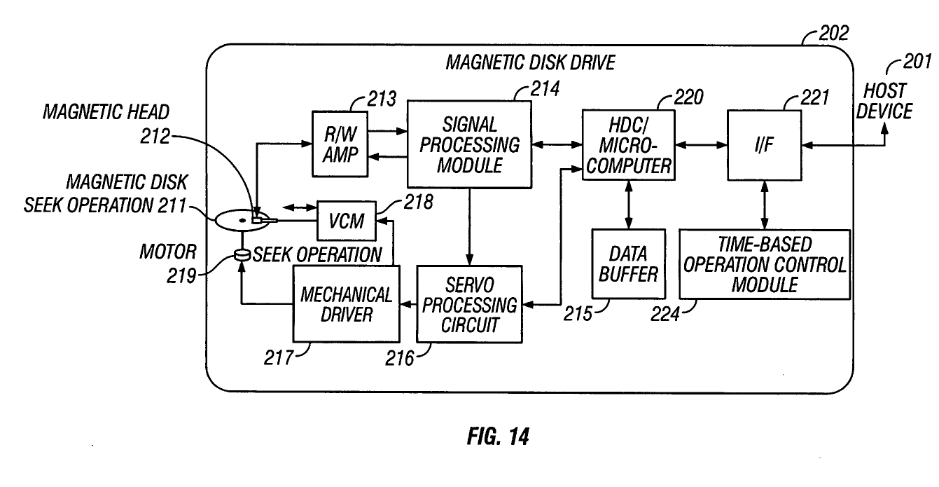

Embodiments of the present invention will now be described in detail with reference to the accompanying drawings. FIG. 14 illustrates the configuration of a first embodiment of a magnetic disk drive 202. The magnetic disk drive 202 according to the first embodiment includes a time-based operation control module 224. The time-based operation control module 224 is connected to an interface 221.

First of all, the configuration of the magnetic disk drive 202 will be described. The interface 221 is connected to a host device 201 such as a host computer or personal computer for the purpose of exchanging a control signal and data. A hard disk controller/microcomputer (HDC/microcomputer) 220, which is an overall control device for the magnetic disk drive, is connected to the interface 221, a data buffer 215, a signal processing module 214, and a servo processing circuit 216 to provide overall magnetic disk drive control, interface control, buffer control, servo control, error correction, and the like. A mechanical driver 217 is connected to the servo processing circuit 216 to control a spindle motor 219 and a voice coil motor (VCM) 218. One or more magnetic disks 211 are installed over a rotation shaft of the spindle motor 219 and rotated at a predetermined speed. The VCM 218 causes a magnetic head 212, which is mounted on a suspension, to perform a seek operation in the radial direction of a rotating magnetic disk 211.

A playback signal, which is picked up from the magnetic disk 211 by the magnetic head 212, is transmitted to the signal processing module 214 via a read/write amplifier (R/W amp) 213. Data that has been subjected to signal processing in the signal processing module 214 is transferred to the host device 201 via the HDC/microcomputer 220 and interface 221. The control signal and write data that are transmitted from the host device 201 are received by the interface 221 and transferred to the HDC/microcomputer 220 and time-based operation control module 224. The signal processing module 214 receives the write data from the HDC/microcomputer 220, subjects it to signal processing, and transmits it to the R/W amp 213. The magnetic head 212 receives the write data transmission from the R/W amp 213 and writes it onto the magnetic disk 211.

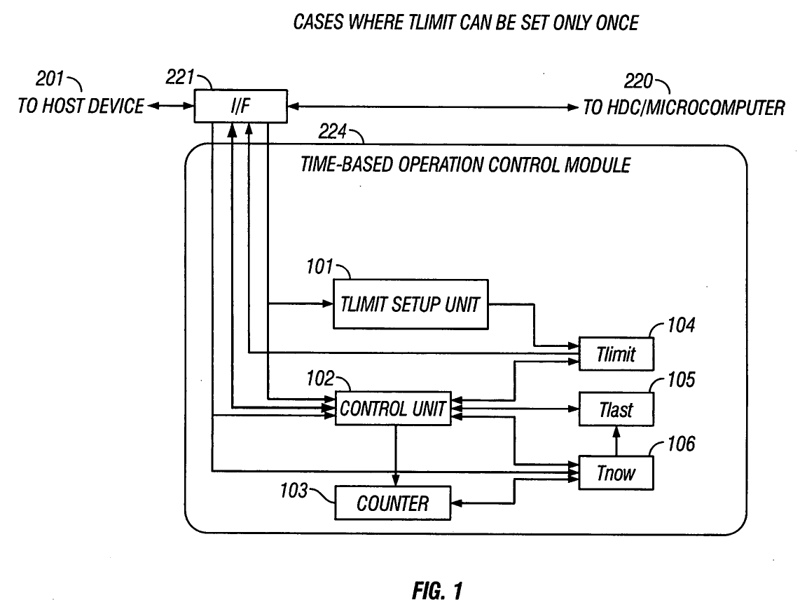

FIG. 1 shows the basic configuration (first embodiment) of the time-based operation control module 224. The time-based operation control module 224 comprises a use time limit setup unit (Tlimit setup unit) 101, use time limit (Tlimit) retention unit 104, control unit 102, last use time (Tlast) retention unit 105, present time retention (Tnow) unit 106, and a counter 103. The employed configuration does not transfer the last use time (Tlast) out of the magnetic disk drive 202. The use time limit (Tlimit) can be set only once.

When the magnetic disk drive 202 is to be used for the first time (at a rental shop), the use time limit (Tlimit) is transferred via the interface 221 and Tlimit setup unit 101 upon command from the host device 201 and retained by the Tlimit retention unit 104. The last use time (Tlast) and present time (Tnow) need to be transferred via the interface 221 and control unit 102 upon command from the host device 201 and set by the Tlast retention unit 105 and Tnow retention unit 106, respectively, until at least the use time limit (Tlimit) is set. These time values may be simultaneously set by using a command for use time limit (Tlimit) setup. Further, the last use time (Tlast) and present time (Tnow) are updated by the counter 103 in coordination with the control unit 102.

For the second and subsequent use of the magnet disk drive 202, the present time (Tnow) is acquired via the interface 221 upon command from the host device 201. The control unit 102 checks the use time limit (Tlimit) and last use time (Tlast) to determine whether the condition for use (Tlast<Tnow<Tlimit) is met. Only when the condition for use is met will the interface 221 permit the HDC/microcomputer 220 to access data upon command from the host device 201. If the condition for use is not met, the interface 221 does not permit the HDC/microcomputer 220 to access data.

The present embodiment described above may be configured so that the time-based operation control module 224 is included in the interface 221. When the above magnetic disk drive 202 is not for rental use (the time limiting function is disabled), it can be used as a regular data recording/playback magnetic disk drive.

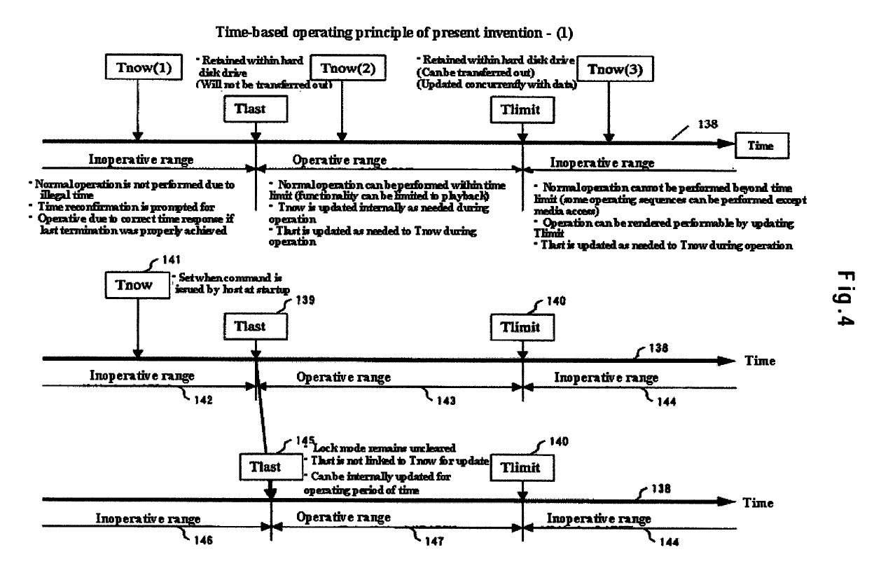

The operating principle of the magnetic disk drive according to specific embodiments of the present invention will now be described with reference to FIGS. 4 through 6. In FIG. 4, the last use time (Tlast) and use time limit (Tlimit) are set along the time base 138, and the present time (Tnow) acquired from the host device 201 is Tnow (1), Tnow (2), or Tnow (3). If the present time (Tnow) 141 is earlier than the last use time (Tlast) 139 as described along the time base 138 (Tnow (1)), the associated region is an inoperative range 142. The data in the magnetic disk drive cannot be accessed within such a range. However, the magnetic disk drive is operating in such an instance. Therefore, the last use time (Tlast) 139 is internally updated for the operating period of time so that last use time (Tlast) 145 results. Further, it is conceivable in this case that the time may be erroneously set by the host device. It is therefore preferred that time reconfirmation be prompted for as a response to a command.

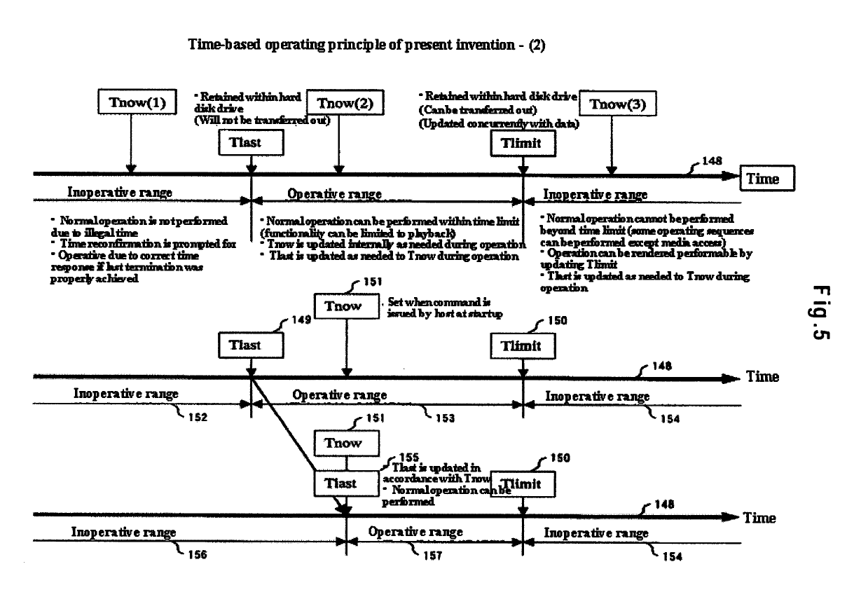

If, as shown in FIG. 5, the present time (Tnow) 151 acquired from the host device is between the last use time (Tlast) 149 and use time limit (Tlimit) 150 as described along the time base 148 (Tnow (2)), the associated region is a normal operative range 153, which permits data access. In this instance, the last use time (Tlast) 149 is updated to be equal to the present time (Tnow) 151 so that last use time (Tlast) 155 is obtained.

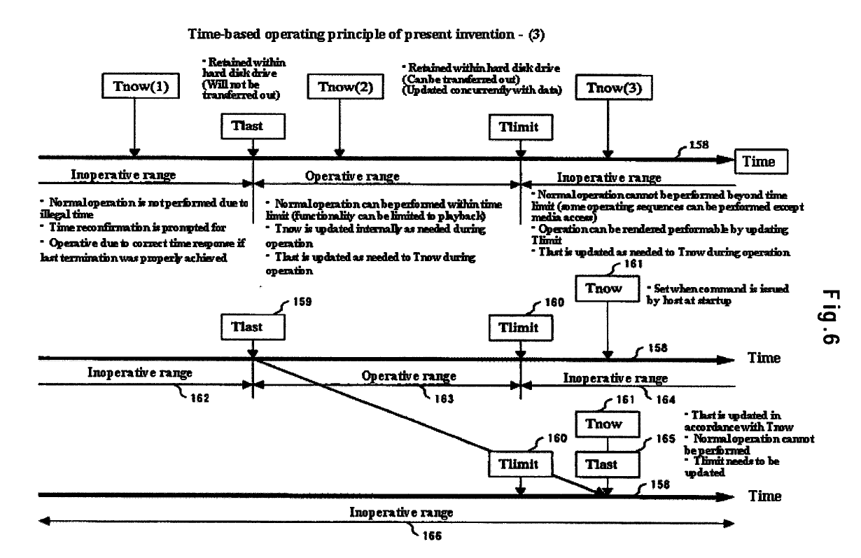

If, as shown in FIG. 6, the present time (Tnow) 161 acquired from the host device is later than both the last use time (Tlast) 159 and use time limit (Tlimit) 160 as described along the time base 158 (Tnow (3)), the associated region is an inoperative range 164, which does not permit data access. In other words, the normal operative range 163 within which data can be accessed disappears, and there is an inoperative range 166 only. In this instance, too, the last use time (Tlast) 159 is updated to be equal to the present time (Tnow) 161 because the acquired present time (Tnow) 161 is considered to be correct. Consequently, last use time (Tlast) 165 is obtained.

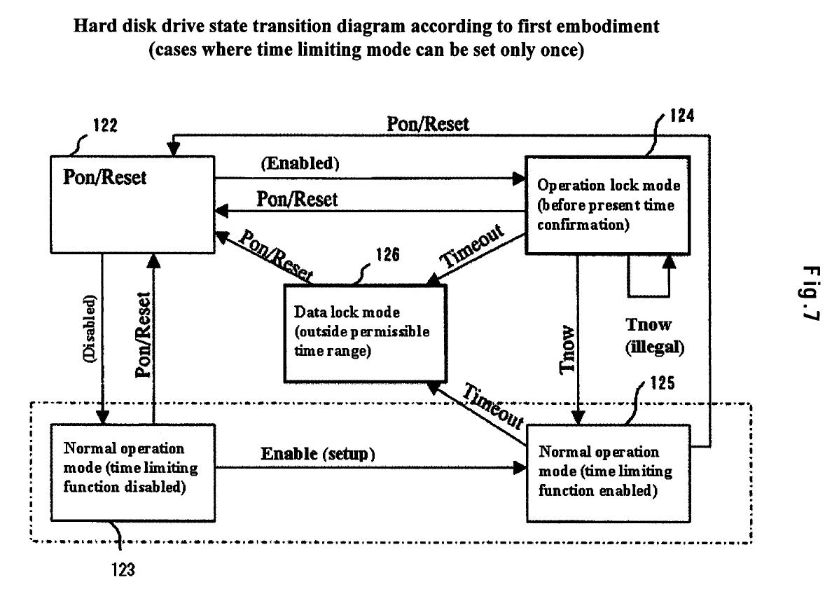

FIG. 7 shows the state transitions of the magnetic disk drive 202 according to the first embodiment, which is described above. Upon power ON (PON) 122, the magnetic disk drive 202 enters an operation lock mode 124 as far as the time limiting function is enabled. In this state, the present time (Tnow) is acquired from the host device. When the condition (Tlast<Tnow<Tlimit) is met, the magnetic disk drive switches to normal operation mode 125. If, on the other hand, the time limit function is disabled, the magnetic disk drive 202 enters normal operation mode 123 upon power ON (PON) 122 and operates as a regular magnetic recording/playback device. If the use time limit (Tlimit) is reached in normal operation mode 125 (while the time limiting function is enabled), a timeout occurs so that the magnetic disk drive 202 enters a data lock mode 126 (within the permissible time range). After entry into the data lock mode 126, the magnetic disk drive 202 cannot switch to normal operation mode 123 or normal operation mode 125.

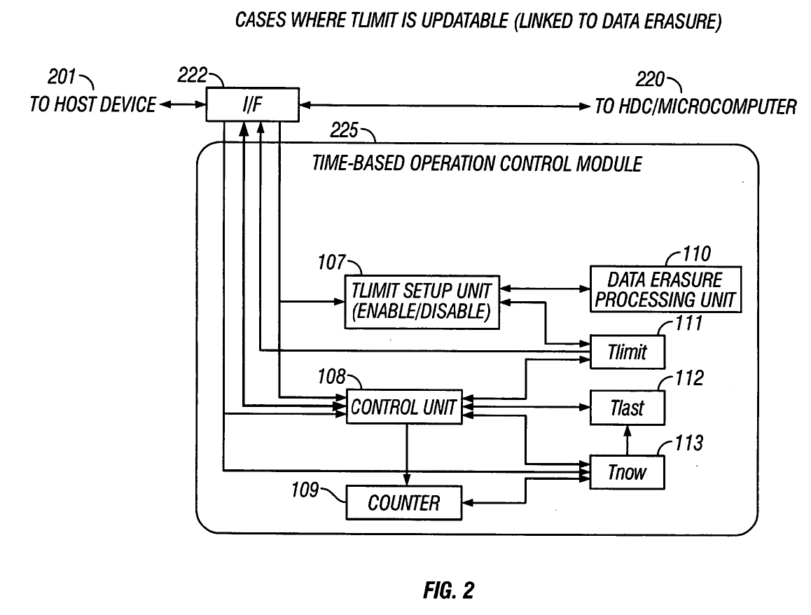

In the first embodiment, which is described above, the use time limit (Tlimit) is set only once (the magnetic disk drive is considered to be disposable). However, the use time limit (Tlimit) can be linked to data erasure and rendered updatable. FIG. 2 illustrates a time-based operation control module 225 according to a second embodiment of the present invention in which the use time limit (Tlimit) is linked to data erasure and rendered updatable. The configuration of the second embodiment differs from that of the first embodiment in that the former includes a use time limit update unit (Tlimit update unit) 107 for updating the use time limit (Tlimit) as well as a data erasure processing unit 110. The Tlimit update unit 107 makes it possible to update the use time limit (Tlimit), thereby permitting repeated use. For protection of contents (data) in this instance, the data erasure processing unit 110 erases the contents that have expired or otherwise become unusable.

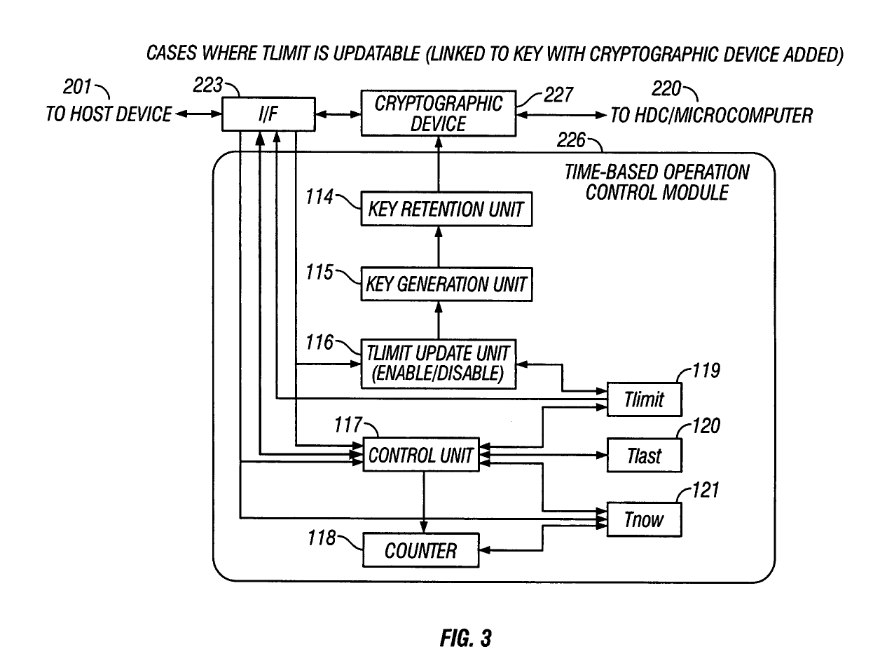

In the second embodiment, which is described above, the use time limit (Tlimit) is rendered updatable. However, several tens of minutes are usually required for erasing the whole data from the magnetic disk drive. Therefore, an inconvenience persists when the magnetic disk drive is frequently used. A time-based operation control module 226 according to a third embodiment, which is shown in FIG. 3, encrypts the contents, records the encrypted contents onto a magnetic disk, and renders the use time limit (Tlimit) updatable with key data about the recorded contents. The configuration of the third embodiment differs from that of the first embodiment in that the former includes use time limit update unit (Tlimit update unit) 116 for updating the use time limit (Tlimit), a cryptographic device 227 for data encryption/decryption, a key generation unit 115 for generating key information about data encryption/decryption, and a key retention unit 114 for retaining the key information.

When the user time limit (Tlimit) is to be updated, the cryptographic key for use with the cryptographic device 227 is newly generated by the key generation unit 115 and retained by the key retention unit 114. This ensures that even if the data already recorded on a magnetic disk is read, the read data cannot be used because the encrypted key and decrypted key do not properly match. When the cryptographic device 227 according to the present embodiment is used, the cryptographic key need not be removed out of the magnetic disk drive. It is therefore possible to generate and retain the cryptographic key in secret within the magnetic disk drive. Consequently, proper protection can be provided for the contents that have expired or otherwise become unusable.

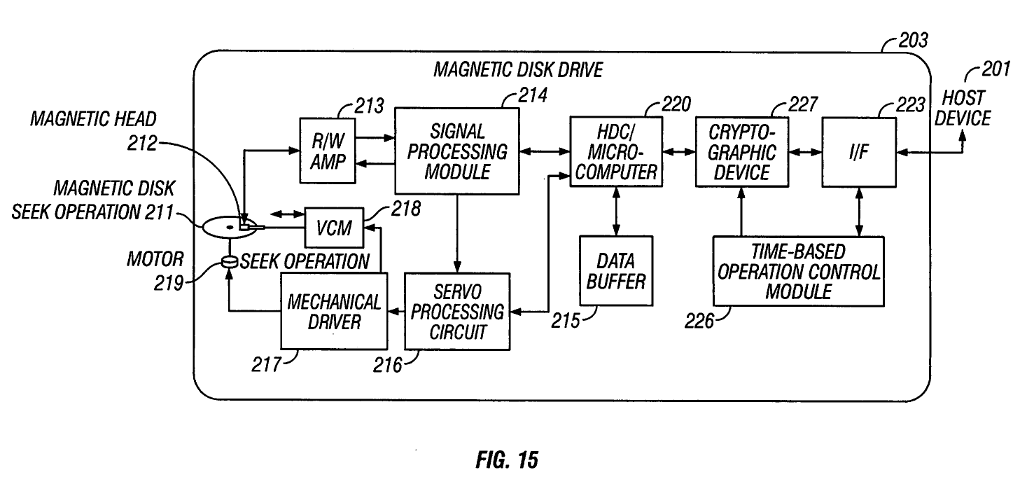

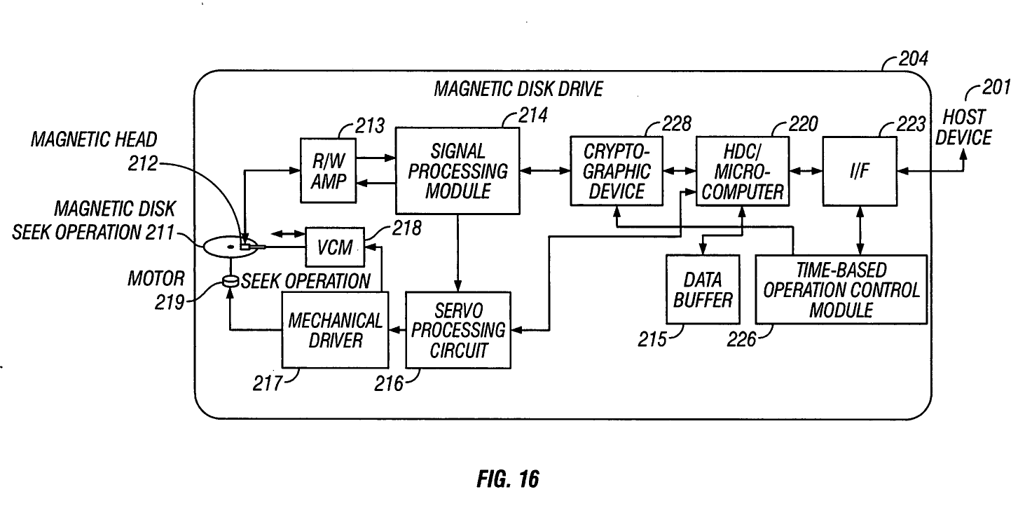

FIG. 15 shows the overall configuration of the magnetic disk drive 203 according to the third embodiment. The cryptographic device 227 is installed between the interface 223 and HDC/microcomputer 220. FIG. 16 shows a modified version of the magnetic disk drive 204 according to the third embodiment. However, the cryptographic device may be installed as a cryptographic device 228 between the HDC/microcomputer 220 and signal processing module 214. In the second and third embodiments, the time-based operation control module 226 may be included in the interface 223.

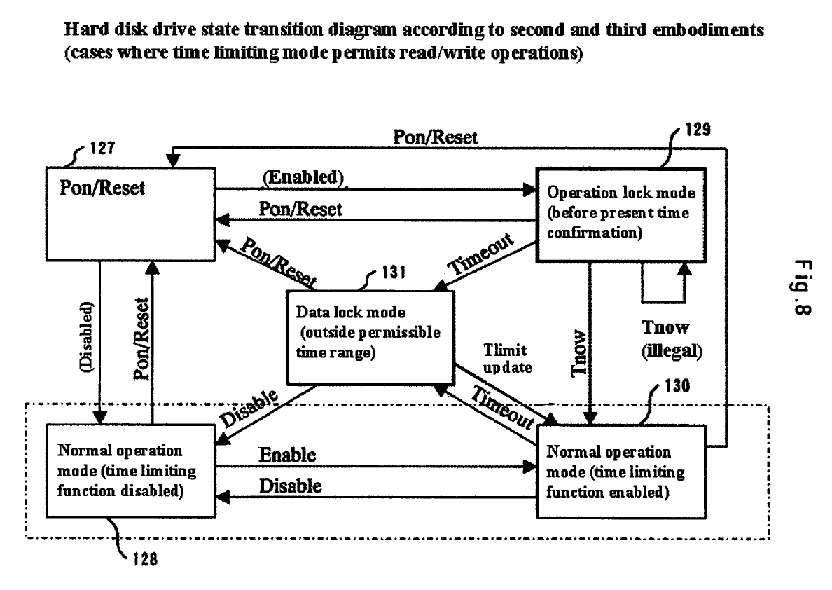

FIG. 8 shows the state transitions of the magnetic disk drive 202 (FIGS. 2 and 14) according to the second embodiment and the state transitions of the magnetic disk drives 203, 204 (FIGS. 3, 15, and 16) according to the third embodiment. Unlike the first embodiment, the second and third embodiments can switch, even after entry into the data lock mode 131, to normal operation mode 130 by updating the use time limit (Tlimit) or to normal operation mode 128 by disabling the use time limiting function.

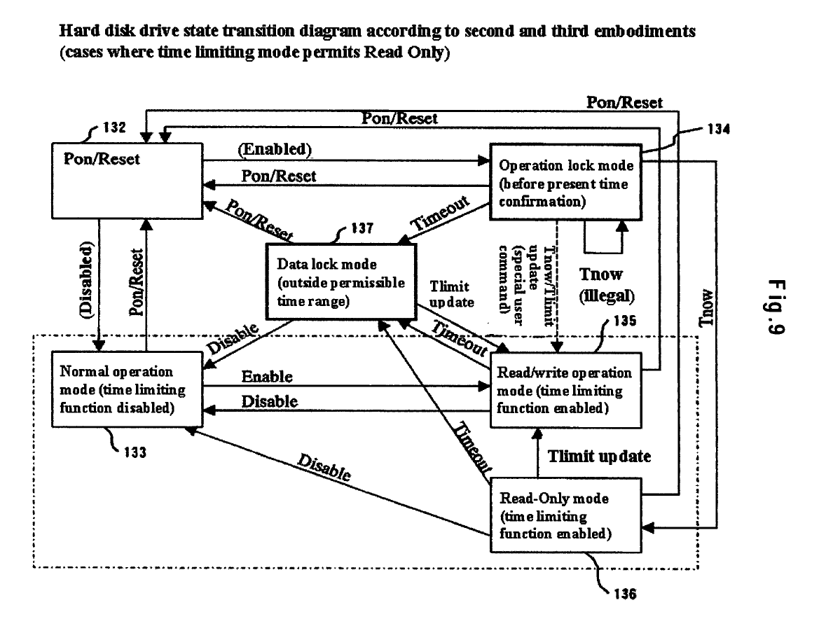

FIG. 9 shows the state transitions that can be applied to the magnetic disk drive 202 (FIGS. 2 and 14) according to the second embodiment and the magnetic disk drives 203, 204 (FIGS. 3, 15, and 16) according to the third embodiment. The state transitions indicated in FIG. 9 are obtained by adding a read-only mode 136 to the state transitions shown in FIG. 8. When the operation is performed in the read-only mode except for use time limit (Tlimit) setup or update, the contents can be protected against erasure. Further, it is difficult to write different data or otherwise use the magnetic disk drive for some other applications.

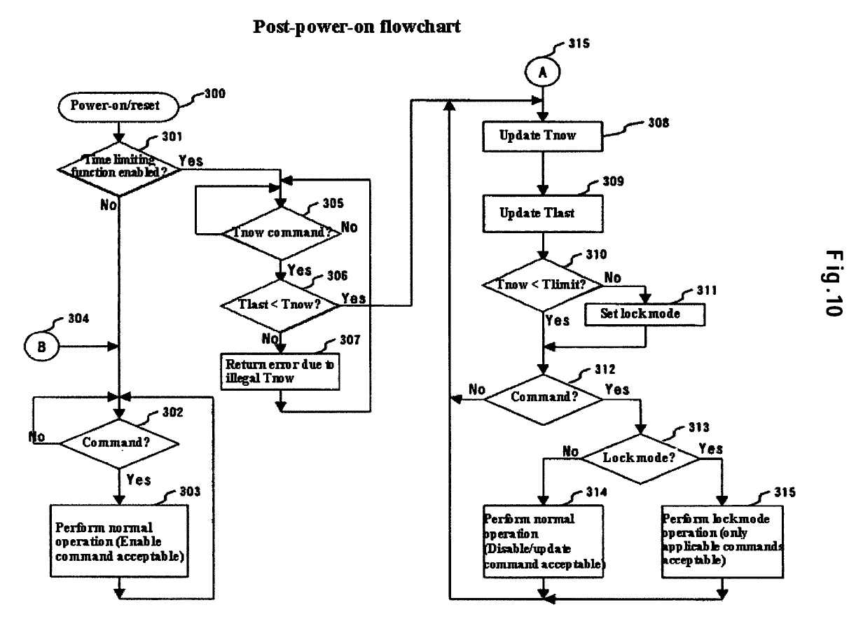

The operation of the time-based operation control modules 224, 226 of the magnetic disk drives according to the first to third embodiments will now be described with reference to the flowcharts in FIGS. 10 through 13. FIG. 10 is a flowchart illustrating an operation that is performed upon power ON. Upon power ON (step 300), step 301 is performed to judge whether the time limiting function is enabled. If the time limiting function is enabled, step 305 is performed to judge whether a present time (Tnow) setup command is received from the host device. If the present time (Tnow) setup command is received, step 306 is performed to acquire the present time (Tnow) and judge whether Tlast<Tnow. If Tlast<Tnow, step 308 is performed to update the present time (Tnow). Step 309 is then performed to update the last use time (Tlast). Next, step 310 is performed to judge whether Tnow<Tlimit. If Tnow<Tlimit, step 312 is performed to judge whether a new command is received. If no new command is received, steps 308 through 312 are repeated. During such a repetition period, the contents of the magnetic disk drive can be used because Tlast<Tnow<Tlimit.

If Tlast is not less than Tnow in step 306, an error is returned to the host device to indicate that the present time (Tnow) is illegal (step 307). The program flow then returns to step 305.

If Tnow is not less than Tlimit in step 310, a command is issued to set the data lock mode (within the permissible time range) (step 311).

If a new command is received in step 312, step 313 is performed to judge whether the command is for data lock mode setup. If the command is for data lock mode setup, step 315 is performed to set the data lock mode. If the command is not for data lock mode setup, step 314 is performed to set a normal operation mode (in which the time limiting function is disabled).

If the time limiting function is disabled in step 301, steps 302 and 303 are followed to set the normal operation mode (in which the time limiting function is disabled).

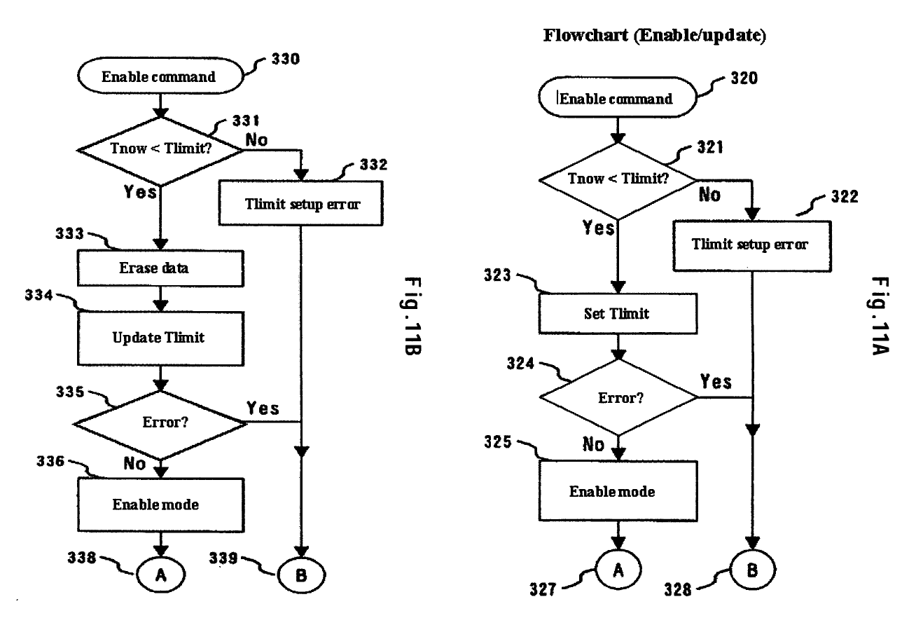

FIG. 11A is a flowchart illustrating how the Enable command operates to enable the use time limiting function for the first time in the first embodiment (FIG. 1) or second embodiment (FIG. 2). The Enable command is processed as a command within step 303, which is shown in FIG. 10. First of all, step 320 is performed to receive the Enable command from the host device to start command processing. Step 321 is then performed to compare the present time (Tnow) against the use time limit (Tlimit) for the purpose of verifying that the use time limit (Tlimit) value is greater than the present time (Tnow) value (Tnow<Tlimit) (the user time limit indicates a future time). The present time (Tnow) and use time limit (Tlimit) can be received from the host device as the data accompanying the Enable command. If the setup condition (Tnow<Tlimit) is met, step 323 is performed to set the use time limit (Tlimit). Step 324 is then performed to check whether an error exists. If no error is encountered, step 325 is performed to enable the use time limiting function and then the program flow proceeds to step 308, which is shown in FIG. 10. Subsequently, the use time limiting function remains enabled. If, on the other hand, the setup condition (Tnow<Tlimit) is not met in step 321, step 322 is followed to perform a use time limit (Tlimit) setup error process and then the program flow proceeds to step 302, which is shown in FIG. 10. As a result, the use time limiting function remains disabled. Further, if an error is detected in step 324, the program flow proceeds to step 302, which is shown in FIG. 10, and the use time limiting function remains disabled.

FIG. 11B is a flowchart illustrating an operation that is performed to update the use time limit (Tlimit) in the second embodiment (FIG. 2). In addition to the operating steps shown in FIG. 11A, step 333 is performed before or concurrently with a use time limit (Tlimit) update to erase the contents (data) when the use time limit (Tlimit) is to be updated.

FIG. 11C is a flowchart illustrating an operation that is performed to set/update the use time limit (Tlimit) in the third embodiment (FIG. 3). In addition to the operating steps shown in FIG. 11A, step 343 is performed before use time limit (Tlimit) setup/update to generate or update the key data.

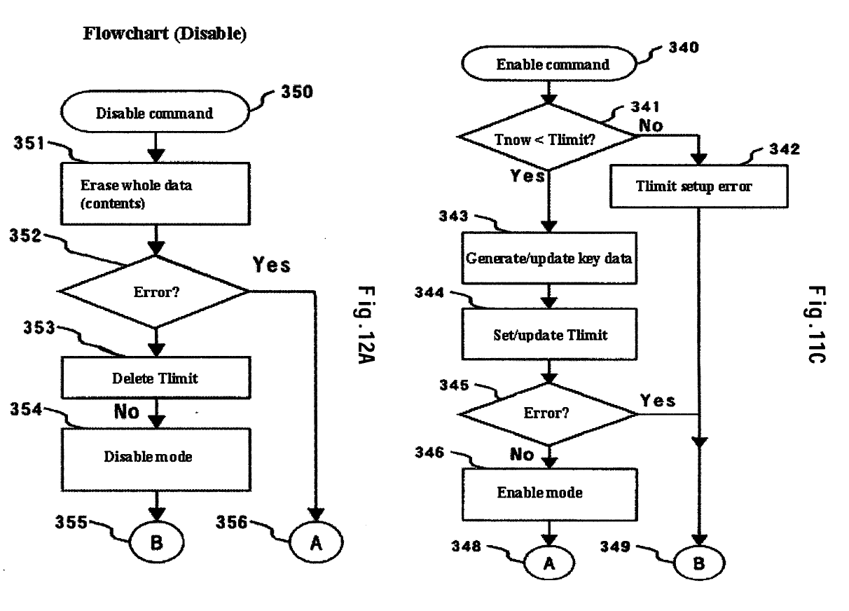

FIG. 12A is a flowchart illustrating the operation of the Disable command, which disables the use time limiting function in the second embodiment (FIG. 2). The Disable command is processed as a command within step 314 or step 315, which are shown in FIG. 10. The Disable command is received from the host device to start command processing (step 350). First of all, step 351 is performed to erase the whole contents. Next, step 352 is performed to check whether an error exists. If no error exists, step 353 is performed to delete the use time limit (Tlimit). After the use time limit (Tlimit) is deleted, step 354 is performed to disable the use time limiting function and then the program flow proceeds to step 302, which is shown in FIG. 10. The subsequent operation is performed with the use time limiting function disabled. If an error occurs in step 352, the program flow proceeds to step 308, which is shown in FIG. 10 and the use time limiting function remains enabled.

FIG. 12B is a flowchart illustrating an operation that is performed to delete the use time limit (Tlimit) in the third embodiment (FIG. 3). The difference from the second embodiment shown in FIG. 12A is that step 361 is performed for delete the key data before use time limit (Tlimit) deletion.

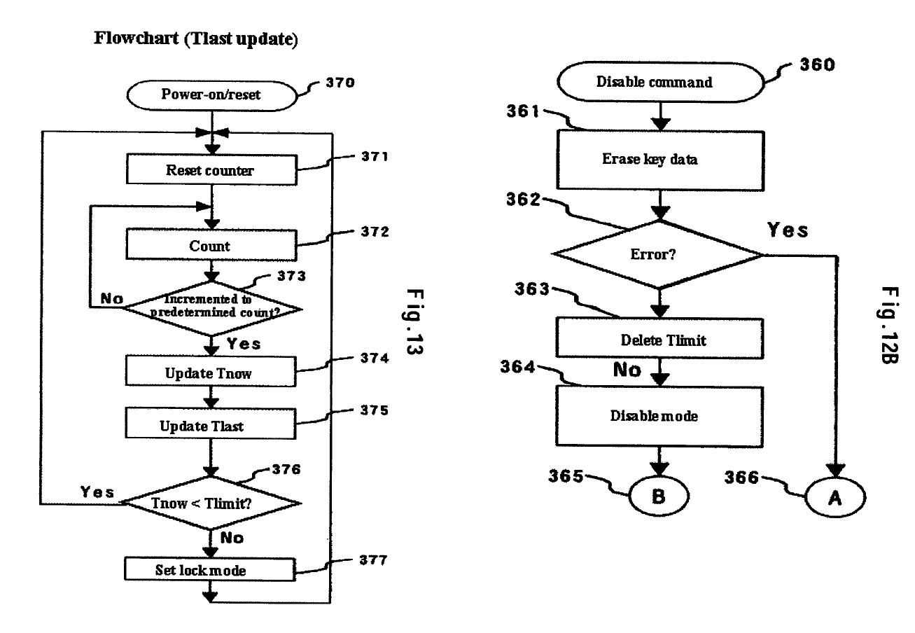

FIG. 13 is a flowchart illustrating an operation that is performed to update the present time (Tnow) and last use time (Tlast) in the first to third embodiments. After power ON (step 370), step 371 is performed to reset the counter 103 (FIG. 1), 109 (FIG. 2),and 118 (FIG. 3), and then step 372 is performed to start counting. Step 373 is performed to check whether the counter is incremented to a predetermined count. If the predetermined count is reached, the present time (Tnow) is updated (step 374) and then the last use time (Tlast) is updated (step 375). Step 376 is then performed to check whether the condition (Tnow<Tlimit) is met. If the condition is met, the program flow returns to step 371. If, on the other hand, the condition is not met, step 377 is performed to set the data lock mode (outside the permissible time range) and then the program flow returns to step 371.

The present invention has been described in conjunction with the first to third embodiments. The present invention retains information about use time within a magnetic disk drive, checks for availability within the magnetic disk drive, and controls the output of the contents within the magnetic disk drive. Therefore, the present invention can properly limit the use time to provide against illegal access that may be attempted from an external device.

Further, if the information about use time limitation within the magnetic disk drive is changed, the contents (data) are doubly encrypted or otherwise manipulated to prevent normal output (playback). Therefore, even when illegal access is gained, the contents can be protected.

Consequently, the magnetic disk drive according to the present invention is suitable for use in a contents rental system or the like. As a result, it is possible to construct an easy-to-handle business model that is similar to a conventional, video-tape-based contents rental system.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims alone with their full scope of equivalents.

1. A magnetic disk drive that incorporates a use time limiting function and includes a magnetic disk for storing contents, a magnetic head for writing contents onto and reading contents from the magnetic disk, and an interface with a host device, said magnetic disk drive comprising:
a use time limit setup unit configured to set a use time limit;
a use time limit retention unit configured to retain the use time limit that is set by the use time limit setup unit;
a last use time retention unit configured to retain the last use time;
a present use time retention unit configured to retain the present time that is transmitted from the host device;
a counter configured to update the present time and the last use time; and
a control unit configured to judge whether the present time is later than the last use time and within the use time limit;
wherein access to the contents on said magnetic disk is permitted when the present time is later than the last use time and within the use time limit.

2. The magnetic disk drive that incorporates a use time limiting function according to claim 1, wherein access to the contents on said magnetic disk is not permitted if the present time is not later than the last use time or not within the use time limit.

3. The magnetic disk drive that incorporates a use time limiting function according to claim 1, wherein the last use time retained by said last use time retention unit is not transferred out to the outside.

4. The magnetic disk drive that incorporates a use time limiting function according to claim 1, wherein said counter updates said present time and said last use time during an operation that is performed after present time acquisition.

5. The magnetic disk drive that incorporates a use time limiting function according to claim 1, wherein, when said use time limit is to be set or updated, said magnetic disk can be written onto, and when said use time limit is not to be updated, said magnetic disk can only be read.

6. The magnetic disk drive that incorporates a use time limiting function according to claim 1, wherein said magnetic disk drive can be used as a regular recording/playback device if said use time limit is not set.

7. A magnetic disk drive that incorporates a use time limiting function and includes a magnetic disk for storing contents, a magnetic head for writing contents onto and reading contents from the magnetic disk, and an interface with a host device, said magnetic disk drive comprising:
a use time limit update unit configured to set and update a use time limit;
a use time limit retention module configured to retain the use time limit that is set by the use time limit update unit;
an erasure processing unit configured to erase the contents of said magnetic disk;
a last use time retention unit configured to retain the last use time;
a present use time retention unit configured to retain the present time that is transmitted from the host device;
a counter configured to update the present time and the last use time; and
a control unit configured to judge whether the present time is later than the last use time and within the use time limit;
wherein access to the contents on said magnetic disk is permitted when the present time is later than the last use time and within the use time limit; and
wherein, when said use time limit is to be updated, said erasure processing unit erases the contents of said magnetic disk.

8. The magnetic disk drive that incorporates a use time limiting function according to claim 7, wherein access to the contents on said magnetic disk is not permitted if the present time is not later than the last use time or not within the use time limit.

9. The magnetic disk drive that incorporates a use time limiting function according to claim 7, wherein the last use time retained by said last use time retention unit is not transferred out to the outside.

10. The magnetic disk drive that incorporates a use time limiting function according to claim 7, wherein said counter updates said present time and said last use time during an operation that is performed after present time acquisition.

11. The magnetic disk drive that incorporates a use time limiting function according to claim 7, wherein, when said use time limit is to be set or updated, said magnetic disk can be written onto, and when said use time limit is not to be updated, said magnetic disk can only be read.

12. The magnetic disk drive that incorporates a use time limiting function according to claim 7, wherein said magnetic disk drive can be used as a regular recording/playback device if said use time limit is not set.

13. A magnetic disk drive that incorporates a use time limiting function and includes a magnetic disk for storing contents, a magnetic head for writing contents onto and reading contents from the magnetic disk, a control device, and an interface with a host device, said magnetic disk drive comprising:
a cryptographic device configured to encrypt contents when the contents are to be stored on said magnetic disk;
a use time limit update unit configured to set and update a use time limit;
a use time limit retention module configured to retain the use time limit that is set by the use time limit update unit;
an erasure processing unit configured to erase the contents of said magnetic disk;
a last use time retention unit configured to retain the last use time;
a present use time retention unit configured to retain the present time that is transmitted from the host device;
a counter configured to update the present time and the last use time;
a key generation unit configured to generate a cryptographic key when said use time limit is set or updated;
a key retention unit configured to retain the cryptographic key that is generated by the key generation unit; and
a control unit configured to judge whether the present time is later than the last use time and within the use time limit;
wherein access to the contents on said magnetic disk is permitted when the present time is later than the last use time and within the use time limit;
wherein, when access is permitted, said magnetic head reads the contents stored on said magnetic disk, said cryptographic device decrypts a code, and the contents are transmitted to the host device via the interface with the host device; and
wherein, when said use time limit is to be updated, said key generation unit generates the cryptographic key to prevent the contents previously stored on said magnetic disk from being used as correct information.

14. The magnetic disk drive that incorporates a use time limiting function according to claim 13, wherein access to the contents on said magnetic disk is not permitted if the present time is not later than the last use time or not within the use time limit.

15. The magnetic disk drive that incorporates a use time limiting function according to claim 13, wherein the last use time retained by said last use time retention unit is not transferred out to the outside.

16. The magnetic disk drive that incorporates a use time limiting function according to claim 13, wherein said counter updates said present time and said last use time during an operation that is performed after present time acquisition.

17. The magnetic disk drive that incorporates a use time limiting function according to claim 13, wherein, when said use time limit is to be set or updated, said magnetic disk can be written onto, and when said use time limit is not to be updated, said magnetic disk can only be read.

18. The magnetic disk drive that incorporates a use time limiting function according to claim 13, wherein said cryptographic device is installed between said interface and said control device.

19. The magnetic disk drive that incorporates a use time limiting function according to claim 13, wherein said cryptographic device is installed on the output side of said control device.

20. The magnetic disk drive that incorporates a use time limiting function according to claim 13, wherein said magnetic disk drive can be used as a regular recording/playback device if said use time limit is not set.
